(19) United States
(12) Patent Application Publication
(10) Pub. No.: US 2011/0004628 A1
(43) Pub. Date: Jan. 6, 2011

(54) AUTOMATED ONTOLOGY GENERATION SYSTEM AND METHOD

(76) Inventors: John M. Armstrong, Junction City, KS (US); Ramona R. Leibnitz, Junction, KS (US)

Correspondence Address: MORRISON & FOERSTER LLP, 755 PAGE MILL RD, PALO ALTO, CA, 94304-1018, US

(21) Appl. No.: 12/918,454

(22) PCT Filed: Feb. 22, 2008
(86) PCT No.: PCT/US08/54778

§ 371 Date: Aug. 19, 2010

(51) Int. Cl. G06F 17/30

(52) U.S. Cl. 707/778; 707/776; 707/E17.099; 707/E17.061

(57) ABSTRACT

An automated method for ontology generation is provided. In one embodiment, a user inputs a single clinical term or portion of a clinical term representing an adverse event that a patient has experienced. In response, the system causes a list of conceptually related terms to be generated.

### FIELD OF THE INVENTION

The invention relates to a computer based ontology generation system for receiving a search term and expanding the term to a list of terms that are related to the received search term.

### BACKGROUND OF THE INVENTION

Medical care and treatment are nearly ubiquitous throughout the population. Such care is commonly provided by a health care provider and may include periodic examinations, diagnoses, and treatments. In some cases, a patient is treated and subsequently experiences an adverse event, i.e., a deterioration in the patient's condition. Currently, there are a number of computer systems available for analyzing whether there is a causal relationship between the adverse event and the treatment.

Such a system may allow, for example, a user to specify the adverse event that the patient is experiencing or has experienced. In response, the system performs a database search to identify all of the sources of information in the database that refer to the adverse event and provides the results of the search to the user. For example, if a user specifies “heart palpitations” as an adverse event, the system searches a database to identify all of the sources of information in the database that refer to “heart palpitations” and provides the results of the search to the user.

Other systems that are currently available allow a user to specify a drug that is or has been administered to a patient and an adverse event that was subsequently experienced by the patient. In response, the system searches a database of Pharmaceutical Package Inserts (“PPI”), the written material prepared by the manufacturer of a prescription drug and that accompanies the dispensation of the drug to a patient, for a discussion of the adverse event within the PPI of the specified drug. For example, if a user specifies “bleeding” as the adverse event and the drug as warfin sodium, the system searches the database of PPIs for the warfin sodium PPI and determines if the PPI for warfin sodium identifies bleeding as an adverse event. The results of the search are provided to the user.

Still other systems are currently known that determine whether there are any known adverse events associated with a combination of drugs. In such a system, the user enters the two or more drugs that a patient is taking or has taken. The system uses this information to search for known adverse events involving a combination or combinations of the specified drugs. The results of the search are provided to the user. For instance, if the user indicates that the patient is taking or has taken “drug A” and “drug B”, the system searches a database to determine if there is one or more known adverse events associated with a patient that has taken “drug A” and “drug B,” and reports the results to the user.

### SUMMARY OF THE INVENTION

Various systems such as described above rely on search terms to perform searching and generate results. The present disclosure recognizes that the input to the search can have a significant impact on the search results. For example, if incorrect search terms are used, the search may yield no results, or incorrect results. In such cases, important health related information may not be available to the user of the system. The present disclosure provides methods and systems that expand search terms received in a query and provides the expanded set of search terms to, for example, a medical assessment system.

In one aspect, provided is a method for generating medical assessment query terms in a medical assessment support system. The method of this aspect comprising: (a) receiving a search term describing an adverse event experienced by a patient; (b) identifying a plurality of clinical terms that are functionally related to the search term; and (c) providing a medical assessment query to database search in a medical assessment support system, the query comprising the plurality of clinical terms. The medical assessment query may further include an identification of a drug/treatment having been applied to the patient, a condition/symptom of the patient, or both.

Identifying the plurality of clinical terms, in an embodiment, comprises (a) determining an ontology that includes the search term, the ontology comprising a plurality of groups of related terms; and (b) identifying the plurality of clinical terms based on predetermined rules related to the plurality of groups of related terms. One or more of the plurality of groups of related terms may comprise a hierarchy of terms that include directly related terms and indirectly related terms, and the plurality of clinical terms comprises each combination of directly related terms of the hierarchy. In another embodiment, identifying the plurality of clinical terms comprises: (a) establishing, using an electronic communication device, a communication link with a systemized nomenclature database that provides a database search based upon a query and identifies synonyms, if any, for the query: (b) sending a query to a systemized nomenclature database using the electronic communication device, the query comprising at least a portion of the search term; and (c) receiving, in response to the step of sending, results of a database search conducted by a systemized nomenclature database based upon the query and identifying any synonyms of the query term(s). Additionally, for each synonym identified by the database search, the method may further comprise (d) sending a query to a systemized nomenclature database using the electronic communication device, the query comprising a synonym; and (e) receiving, in response to the step of sending, results of a database search conducted by a systemized nomenclature database based upon the query and identifying any synonyms of the search term. Identifying the plurality of clinical terms may also include removing any redundant clinical terms identified in results of the database searches.

In another embodiment, identifying the plurality of clinical terms comprises: (a) determining an ontology that includes the search term, the ontology comprising a plurality of groups of related terms; (b) identifying a plurality of query terms based on predetermined rules related to the plurality of groups of related terms; (c) establishing, using an electronic communication device, a communication link with a systemized nomenclature database that provides a database search based upon a query and identifies synonyms, if any, for the query; (d) sending a query, for each identified query term, to a systemized nomenclature database using the electronic communication device, the query comprising at least a portion of an identified query term; and (e) receiving, in response to the step of sending, results of a database search conducted by a systemized nomenclature database based upon the query and identifying any synonyms of the query term(s). Furthermore, identifying the plurality of clinical terms, in an embodiment, further comprises, for each synonym identified by the database search: (f) sending a query to a systemized nomenclature database using the electronic communication device, the query comprising a synonym; and (g) receiving, in response to the step of sending, results of a database search conducted by a systemized nomenclature database based upon the query and identifying any synonyms of the search term. Identifying the plurality of clinical terms may also comprise removing any redundant clinical terms identified in results of the database searches.

In still a further embodiment, identifying the plurality of clinical terms comprises: (a) providing the plurality of clinical terms to a third party for review; (b) storing the reviewed clinical terms; and (c) providing the reviewed clinical terms as the plurality of clinical terms in response to receiving the search term.

Another aspect of the present disclosure provides a method for providing an ontology-based search term expansion, comprising: (a) establishing a communication link with an automated ontology generation system using an electronic communication device; (b) sending a query to an automated ontology generation system using the electronic communication device, the query comprising a search term; (c) receiving, in response to the step of sending, a plurality of related search terms from an automated ontology generation system and from a database search conducted by a systemized nomenclature database based upon the query and identifying any synonyms of the query term. The plurality of related search terms may be determined from an ontology that includes the search term, the ontology comprising a plurality of groups of related terms, and being based on predetermined rules related to the plurality of groups of related terms. In an embodiment, one or more of said plurality of groups of related terms comprises a hierarchy of related terms including directly related terms and indirectly related terms, and the plurality of clinical terms comprises each combination of directly related terms of the hierarchy.

In a still further aspect, the present disclosure provides a system for providing an ontology-based search term expansion. The system of this aspect comprises (a) an user interface for receiving a query from an electronic communication device associated with a user and sending the results of a search term expansion based on the query to an electronic communication device associated with the user; (b) a processing engine for determining an ontology based upon a query received by the input interface and providing a plurality of search terms to the user interface for subsequent transmission to an electronic communication device associated with the user; and (c) a data interface for conducting communications with an external data source that may be able to provide one or more synonyms relevant to the query. The processing engine of this aspect comprises an ontology processor for processing at least a portion of the query to produce additional search terms based on an ontology of a plurality of ontologies that includes the search term, the ontology comprising a plurality of groups of related terms.

In am embodiment, the plurality ontologies comprise groups of related terms, at least one ontology comprising a hierarchy of related terms; and the ontology processor produces the additional search terms based on predetermined rules corresponding to relationships of terms of the hierarchy. The query may be a repeating query that identifies one or more additional search terms based on synonyms provided from the external data source, the processing engine repeatedly searching for additional search terms based on the repeating query. The processing engine may remove any redundant clinical terms identified in the queries.

### BRIEF DESCRIPTION OF THE DRAWINGS

FIG. 1 illustrates a flow chart diagram illustrating an exemplary embodiment of the present disclosure;

FIG. 2 illustrates a search input screen of a medical assessment system that may be used in an exemplary embodiment;

FIG. 3 illustrates a flow chart diagram of the operations of a method of an exemplary embodiment;

FIGS. 4A through 4O illustrate an exemplary heart dysfunction ontology;

FIG. 5A and 5B illustrate an exemplary diarrhea ontology;

FIGS. 6A through 6D illustrate an exemplary pancreas dysfunction ontology:

FIGS. 7A through 7D illustrate an exemplary liver dysfunction ontology; and

FIGS. 8-12 illustrate a search input screens for a SNOMED CT search that may be used in an exemplary embodiment.

### DETAILED DESCRIPTION

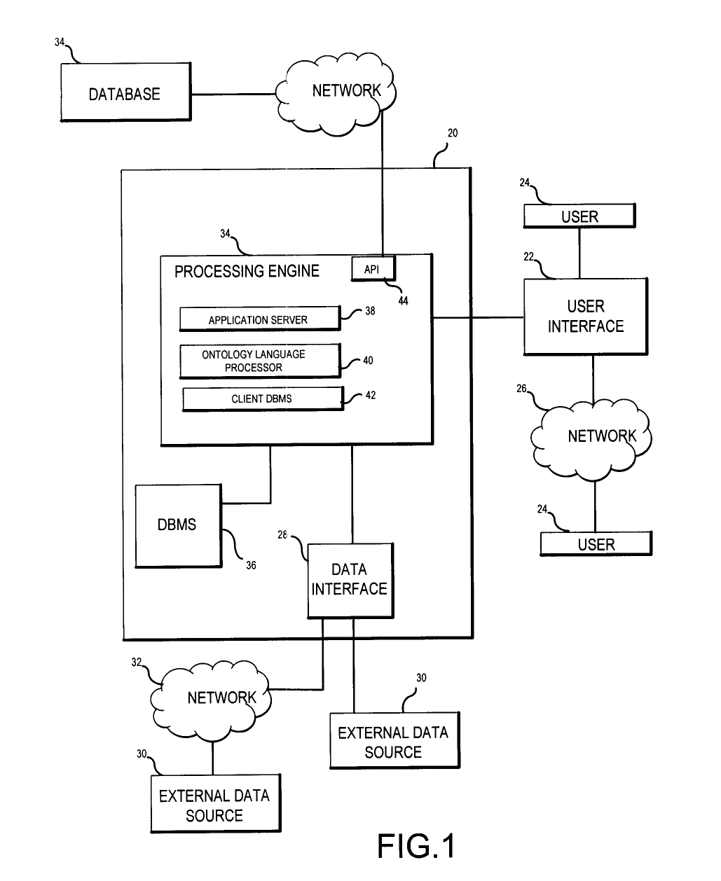

FIG. 1 illustrates an embodiment of an ontology-based search term expander that is incorporated in a medical assessment support system for providing information relating to adverse events according to the invention. Such a medical assessment system may be similar to that described in copending PCT patent application No. PCT/US2007/076583, filed on 22 Aug. 2007 and entitled “Medical Assessment Support System and Method, the entire disclosure of which is incorporated herein by reference. Such a medical assessment support system may be provided with information that includes conditions/symptoms of a patient, drugs/treatments of a patient, medications/treatments of a patient, and adverse events, and output information related to these inputs. The system 20 is comprised of: (a) a user interface 22 that facilitates communications between the system 20 and an electronic or computing device associated with a user 24 that may be directly connected to the user interface 22, or connected through a network 26. A data interface 28 facilitates communications between the system 20 and one or more external sources 30 of data or information that are used to service a query that a user communicates to the system 20 over the user interface 22. The external data source(s) 30 may be directly connected to the data interface 28, and/or connected through a network 32 connection. A processing engine 34 causes one or more searches of data or information sources to be conducted in response to a user query submitted over the user interface 22 and provides the results of the search or searches to the user over the user interface 22.

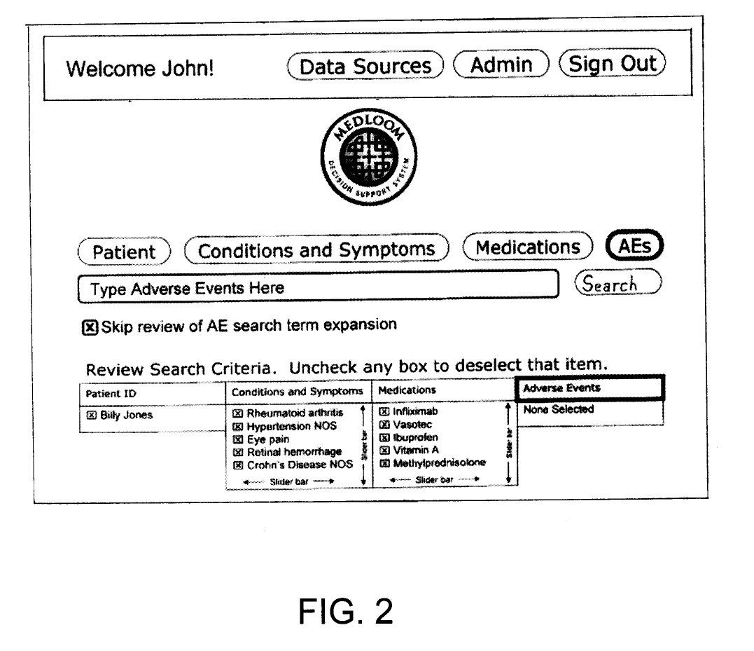

With continuing reference to FIG. 1, the user interface 22 may be comprised of a web server that is capable of communicating with a client Web browser enabled electronic or computing device that is associated with a user 24 through network 26. The electronic or computing devices that the user interface 22 is capable of communicating with include, but are not limited to, personal computers, PDAs, and cell phones that are capable of running a Web browser. The user interface 22 in such an embodiment may provide the client browser with a display of a form that contains fields that are linked to a Data Base Management System via Cache Server Pages (CSP). In an exemplary embodiment, the user interface 22 and client browser maintain a one-to-one association that includes, but not limited to the following: (1) a drug information, or medication, entry field(s); (2) an ailment information entry field(s); and (3) an Adverse Event information entry field(s). FIG. 2 illustrates an exemplary browser window that includes the noted fields. All fields, in this embodiment, are linked to information stored internally in a database management system (DBMS) 36. It should be appreciated that the user interface 22 can include any type of server should communications with one or more users need to be conducted over a network (wide-area or local-area) other than the Web. The user interface 22 also is capable of communicating with an electronic or computing device that is associated with a user and capable of HL7 messaging, a messaging standard that is widely used in the healthcare industry, and also may be adaptable to other messaging protocols that are present in the healthcare industry or are adopted by the healthcare industry in the future.

The user interface 22, in an embodiment, may also comprise a custom integration solution interface that allows a user 24 to bypass a web browser window and directly access the database management system or systems associated with the processing engine 34. Such a custom integration solution interface could accept queries that are in accordance with relational database or object-oriented database protocols. For example, the interface may be capable of receiving relational database queries that utilize ODBC or JDBC protocols for SQL-type queries and transmitting responses in an SQL format. The interface is also capable of receiving queries based on JAVA, C++, VB, SOAP, .NET etc. and transmitting responses in the appropriate format. The interface is capable of being adapted to integrate with other protocols should the need arise. The ability to process relational or object-oriented database queries is realized by basing the processing engine 34 on CACHE, which is protocol-intelligent, i.e., capable of recognizing the protocol upon which a query is based. It should be appreciated that any other system that is protocol-intelligent could also be employed.

With continuing reference to FIG. 1, the data interface 28 is used to transmit requests for data or information to external data sources 30, which are typically commercial data sources but may also include private, proprietary, or public data sources, and receive data or information from these sources that is utilized to build one or more databases that are part of the processing engine 34. In one embodiment, the data interface 28 is used to transmit requests to data sources that provide biomarker data, safety data, pharmaceutical package insert (PPI) data, pharmaceutical company medical information (MI) letters, white papers, clinical trial data, microarray data, genomic and/or proteomic data, single nucleotide polymorphisms (SNPs), drug-response simulation systems, etc. and receive the responses to any such requests. The data interface 28 is capable of transmitting requests and receives responses to one or more data sources 30 that provide a subset of the noted types of data or information. In one exemplary embodiment, the data interface 28 is a back end communication interface that supports all major communication protocols including HL7, XML, JDBC, ODBC and others. The data interface 28 can include the ability to communicate with disparate external systems and use internal class structure to parse and merge data into the DBMS 36 quickly and efficiently. The DBMS 36, in an embodiment, stores the data in a variety of different ways (object, relational tables, and/or other) and can quickly respond to relational or object queries.

With continuing reference to FIG. 1, the processing engine 34 comprises: (a) an application server 38 that processes each query presented by a user via the user interface 22; (b) an ontology language processor 40, (c) a client database management system 42 that is capable of causing a search or searches for adverse events based upon a user specified combination of drugs) and ailment(s), a search or searches based on user specified adverse event(s) and at least one of an ailment(s) and drug(s), providing metrics to users that quantify the benefit of the system to the user, and monitoring continuing medical education credits for users that are health care providers based on the use of system, and/or (d) an application program interface (API) 44 that allows access to an electronic medical record database 46, de-identified or otherwise, that resides outside the system 20 but that is accessible to the system 20. In the illustrated embodiment, the processing engine 34 is a multi-dimensional Post Data Base Management System that stores data as object (Objects) and tables (SQL Relational). Data can be accessed directly using object oriented languages (.net, Java, XML etc.) and/or database languages that adhere to the SQL, DBMS relational industry standard. The DBMS 34 utilizes a transactional bit-map indexing scheme to enhances user response time.

In the illustrated embodiment, one or more elements of the processing engine 34 are capable of responding to a number of different types of queries that include search terms from a user 24, and generating a search query that included expanded search terms based on the received search term. In various embodiments, a search term may be entered into a user interface, and the search term expanded to help ensure that the proper information is presented as a result of a search query that is run on the search term. When using the term “search term,” reference is made to one or more words that are received from an interface that are directed to an item of interest that is desired to be searched. If the data repository includes information that, while referring to the concept that was received at the interface, uses a different nomenclature, the relevant information may not be generated from a search. For example, in a medical assessment system, a user may enter a search term that corresponds to an adverse event, such as “abnormal heart rhythms.” However, one or more of the external data sources that are accessed by the processing engine may include information related to such an event under a category of “arrhythmias.” In such a case, the highly relevant information from the external data source would not be returned in a search results list because of this difference in the terminology used in the search term and the external database.

Embodiments of the present disclosure provide for search term expansion that, upon receiving a search term, expands the search query to include a number of different or alternative search terms that are likely to generate relevant results from a search. Embodiments disclosed herein provide for ontology-based search term expansion, and provide a number of different ontologies related to various different conditions. If a search term is entered that is included in an ontology, other search terms are determined based on the ontology. Thus, embodiments provide for an Automatically Generated Ontology (AGO) that is a list of search terms, all of which are functionally related to a single clinical term entered by the user. The clinical term, in some embodiments, refers to an adverse event entered by a user. In an embodiment, the user interface provides a web based interface into which a user may enter a search term and, through autofill functionality, an AOG compares the entered term, also referred to as a preferred term (PT) to a “universe” of variable Dysfunction Ontologies in order to further expand the PT to include related clinical terms.

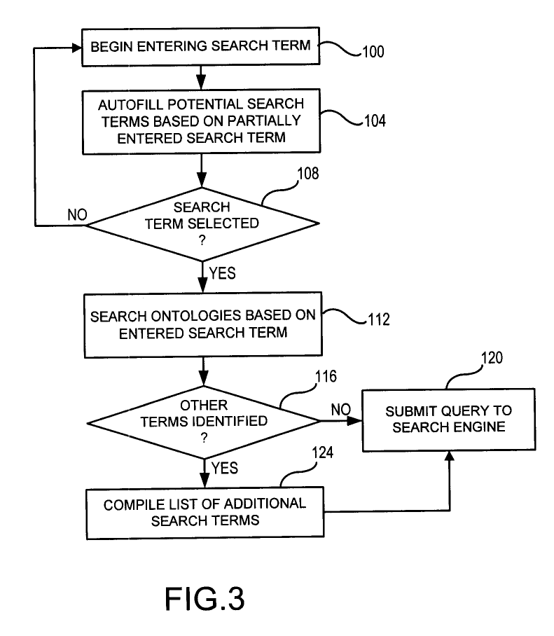

With reference now to FIG. 3, the operations of an embodiment are described. In this embodiment, a search term is started to be entered, as illustrated at block 100. The search term may be entered by a user into a user interface such as through a web accessible finable form. As the user types, at block 104, an autofill function determines potential search terms based on the partially entered search term. For example, a user may start entering a search term into a web accessible finable form, and the autofill function may recognize the initial letters entered, and provide one or more options for search terms that start with the entered letters. It will be understood that other embodiments may simply receive an entire search term either from a user or from an automated system, and thus an autofill function is not used. If an antufill function is used, a user may find such a function convenient as reducing the probability of typing errors and reduced time for typing in a search term. At block 108, it is determined if a search term is selected. If a search term is not selected, such as by selecting an autofill term or entering a confirmation that a search term has been completely entered, the operations beginning at block 100 are repeated. If it is determined at block 108 that a search term has been entered, a search is conducted, at block 112, on ontologies stored in a DBMS associated with the processing engine based on the entered search term. At block 116, it is determined if other search terms are identified from the ontologies. The determination of other search terms is described in more detail below. If no other search terms are identified, a query is submitted to a search engine, as indicated at block 120. Such a query may be generated for an internal data source, and/or one or more external data sources.

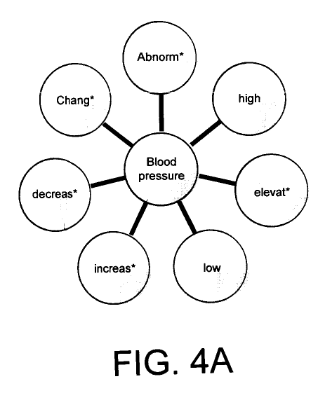

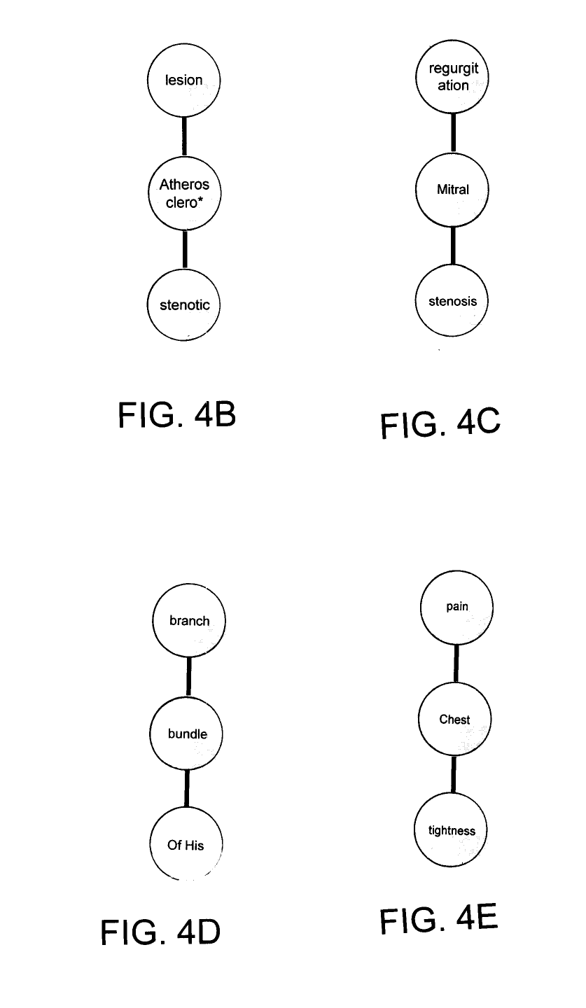

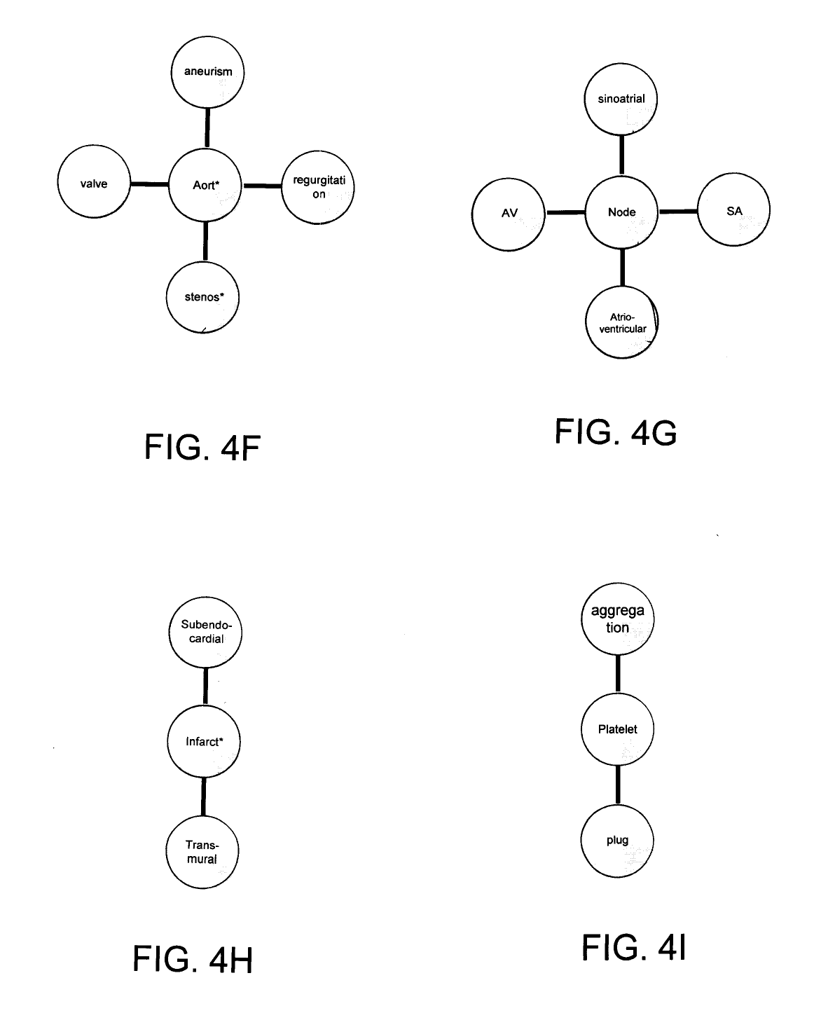

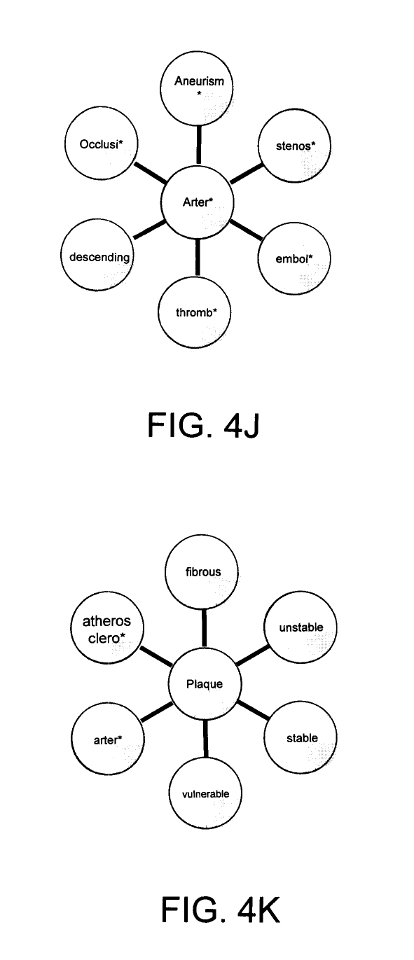

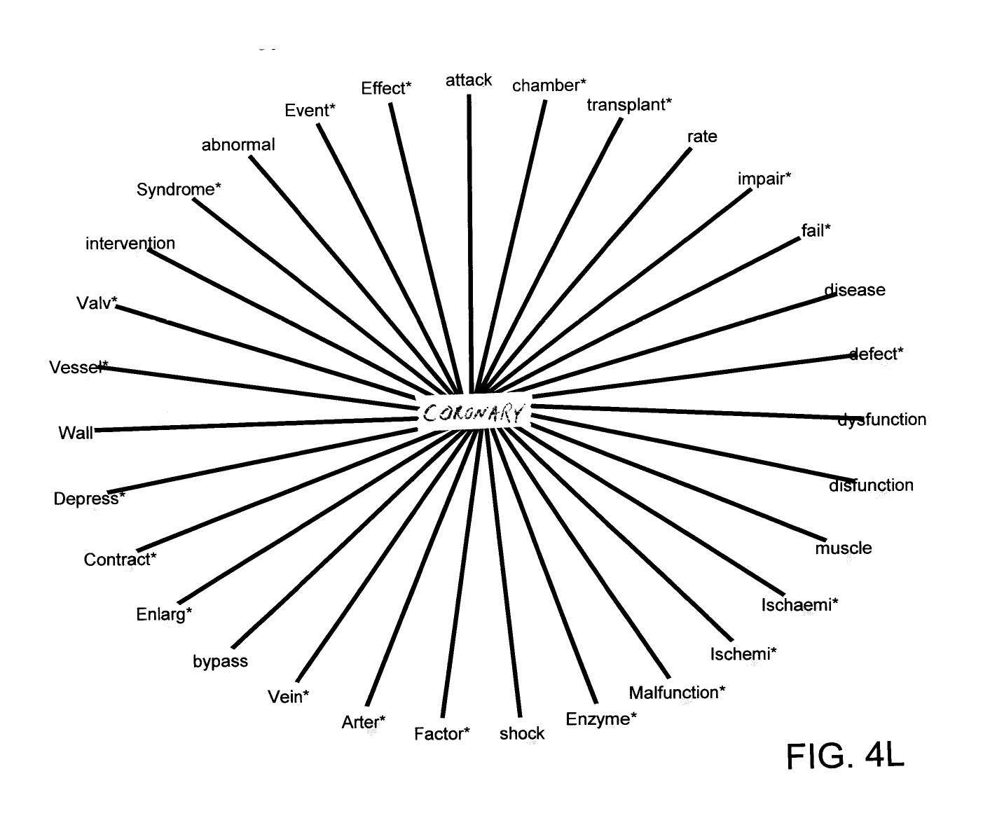

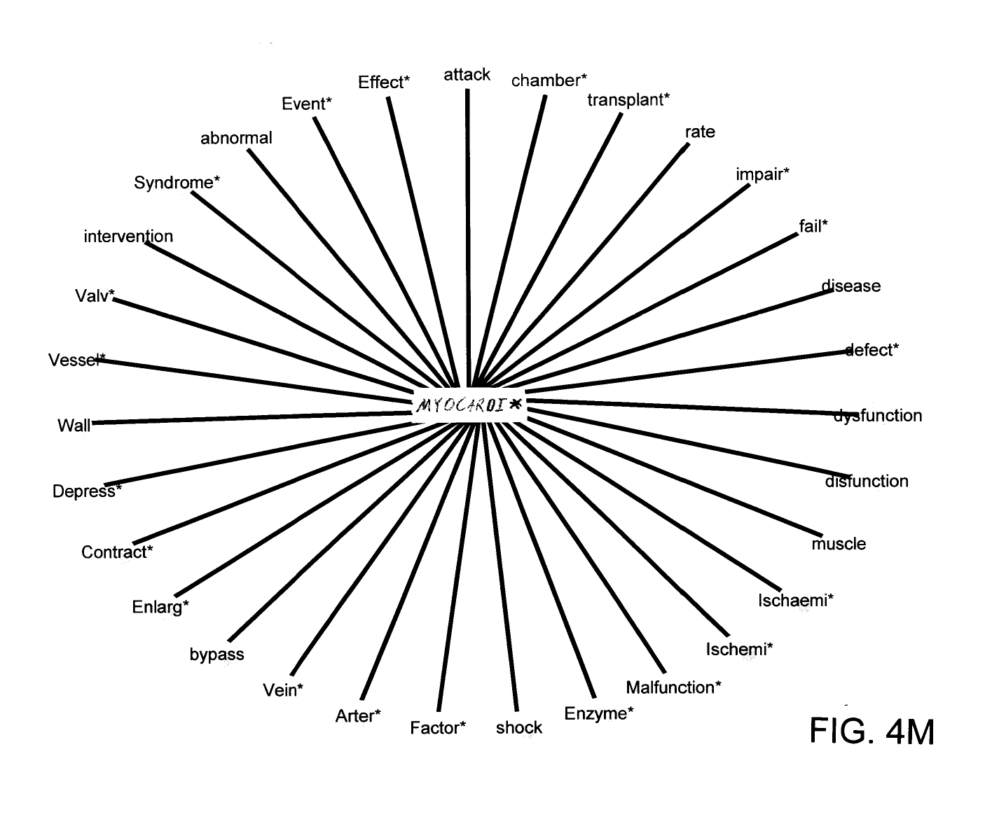

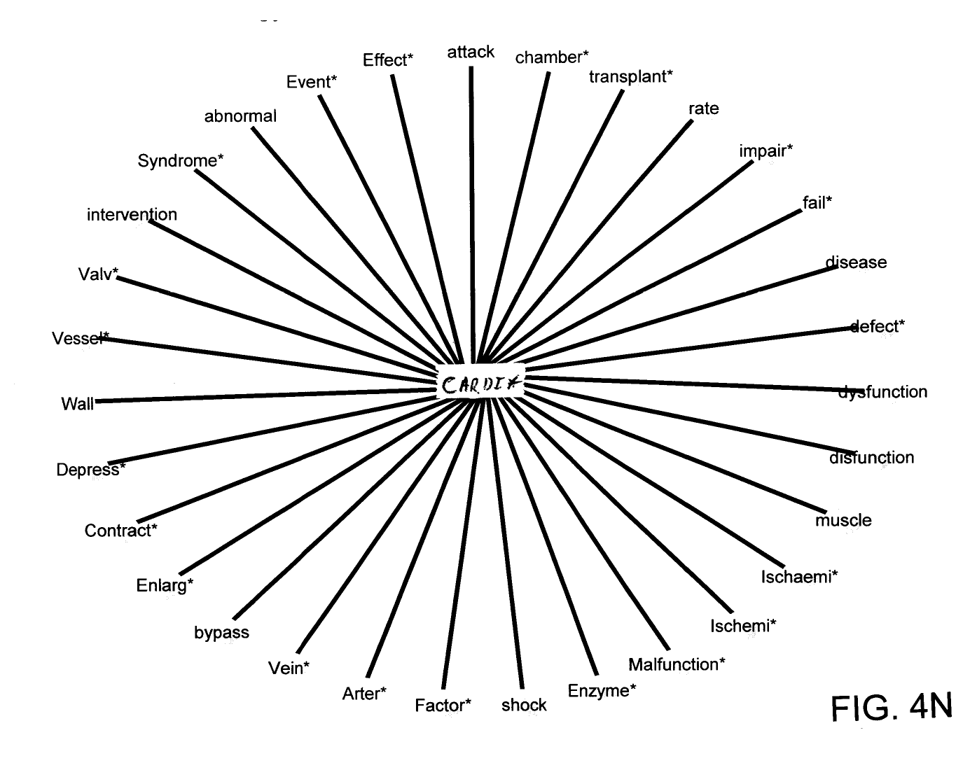

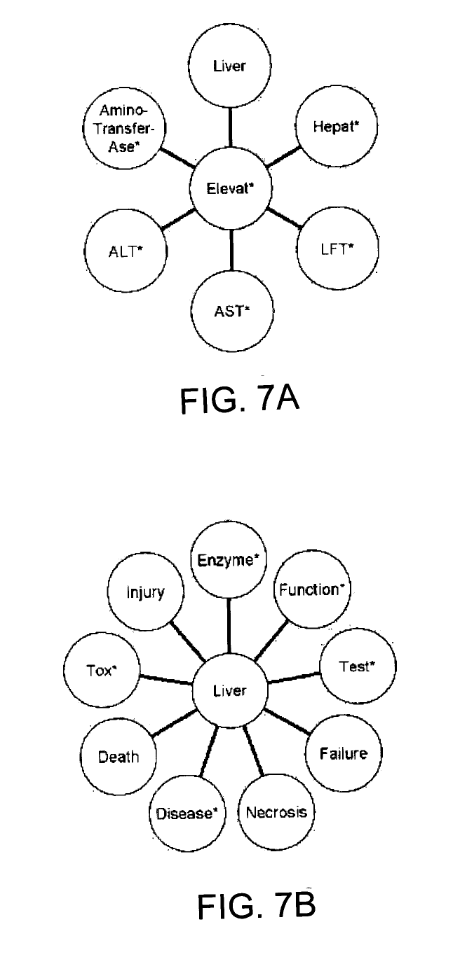

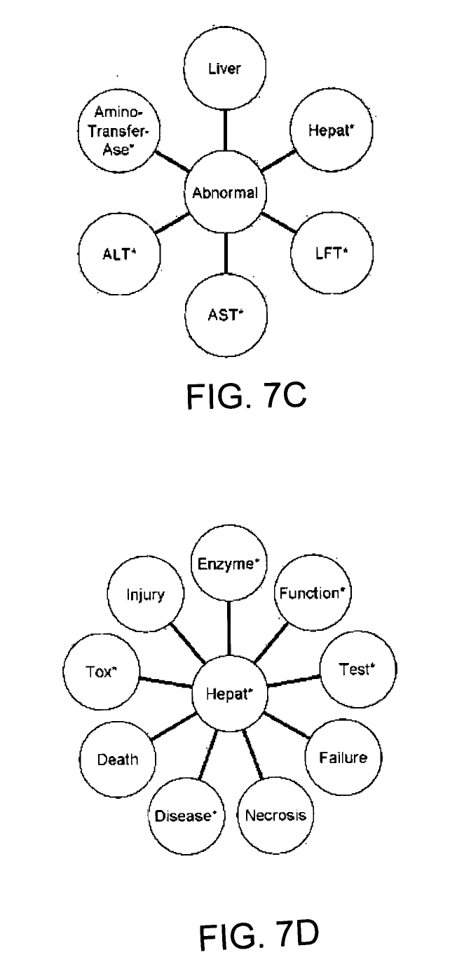

The determination of other search terms, in an exemplary embodiment, is performed through an ontology language processor within a processing engine, such as illustrated in FIG. 1. The processing engine operates to conduct one or more database searches of the databases either maintained by the system 20 or available to the system 20 to identify an expanded set of search terms that are clinically relevant to the entered search term. Four exemplary dysfunction ontologies are illustrated in FIGS. 4-7. In one embodiment, these ontologies are included in a DBMS, such as DBMS 36 of system 20 illustrated in FIG. 1. Such ontologies may, as will be readily understood, be included in one or more external data sources. In one embodiment, the system 20 performs automated ontology generation in real time upon receiving a search term from the user interface 22. The user interface receives a search term. For example, the search term may be “Elevated LFTs,” which represents the adverse event “Elevated Liver Function Tests.” The ontology language processor searches the various dysfunction ontologies available for the search term “Elevated LFTs,” which is found in the “Liver Dysfunction Ontology” of FIG. 7A. In this example, the ontology language processor 40 performs a search of the dysfunction ontologies, the search including truncation and stemming type searching, and finds Elevat* connected to LFT* on an index derived from the ontology of FIG. 7A. Since the string “Elevated LFTs” can be generated from the string “Elevat* LFT*” found in FIG. 7A, all possible terms that can be derived from this dysfunction ontology of FIG. 7 are generated and added to the automatically generated ontology. In the example of FIG. 7, this results in 30 terms that are available from each of FIGS. 7A through 7D. In other exemplary ontologies, such as the heart dysfunction ontology of FIG. 4, potentially hundreds of clinical concepts can be generated from an identified dysfunction ontology, with nearly every term containing more than one word.

Each ontology may also include independent terms that are not related to other terms in groupings of terms for a dysfunction ontology. In the embodiment of FIG. 4. the heart dysfunction ontology includes a number of groups of terms that are related to each other, the terms having direct relations and indirect relations. In the illustrated examples, directly related terms are identified as being connected by a line. Each ontology may include a number of independent terms that are not necessarily directly related to any other terms. For example, the heart dysfunction ontology of FIG. 4 may include independent terms:

ACS; abrupt vessel closure; afterload; AHA; AMI; aneurysm; angina; angiogra*; anticoagula*; aort*; arrhythmia; atherosclero*; Atri*; backward effect; angioplast*; CABG; CAD; Cardiac; Cheyne-Stokes respiration; C reactive; C-reactive; CK; CK-MB; CRP; clot*; coagula*; coronary; Cor pulmonale; creatine kinase; cyanosis; Diastol*; dyspnea; ECG; echocardiogra*; ejection fraction; EKG; electrocardiogra*; embol*; endocardi*; epicardi*; exertional dyspnea; fibrin*; Factor VIII; fibrillat*; filling time; foam cells; forward effects; Framingham heart study; Frank-Starling mechanism; GP 2b/3a; GP 2b3a; GP IIb IIIa; GP IIb/IIIa; HDL; heart; hemosta*; heparin; Holter monitor; hsCRP; hypercholesterol*; hypercoag*; hypertensi*; hypertroph*; IIb/IIIa: inotropic; interventricular septum; intra-aortic balloon; irregular pulse; Ischemic attack*; Ischaemic attack*; lactate dehydrogenase; LAD; LCA; LCX; LD; LD1; LDL; lipoprotein*; LMWH; LVEDP; LVEDV; LVEF; malfunction* heart; MI; muddy streaks; MUGA; Multiple-gated acquisition scanning; mural thrombi; myocardi*; myoglobin; non-cardiovascular; non-Q; NQMI; NYHA; PAAD; pacemaker; palpitations; PAOD; paroxysmal nocturnal dyspnea; patent ductus arteriosus; PCI; PDA; pericardi*; pericardi* effusion; PND; preload; Prinzmetal's; prothrombin; PTCA; Purkinje; PVC; QRS complex abnormalities; Q wave*; RAA; RCA; renin-angiotensin-aldosterone; S3 gallop; ST segment; SEMI; SGOT; sinoatrial; stenotic; stent; stroke; subendocardial; substernal heaviness; sudden death; systol*; tachycardia; tachypnea; tetralogy of Fallot; third heart sound; thromb*; thyrotoxicosis; troponin*; T-wave inversion; vasoconstriction; vena cava*; ventric*; VLDL; and von Willebrand's Factor.

A rule set may be established and used by the ontology language processor 40 in performing search term expansion derived from dysfunction ontologies. Such a rule set may include, for example, that terms from each grouping of terms in a dysfunction ontology can be used for a search only if the term is tied directly to another term in that group. If a term is tied directly to another term in that group, or if any of the independent terms is entered as a search term, then a search query must include all possible strings of directly related terms from each grouping in an ontology as well as all of the independent terms from the ontology. Redundant terms may be removed from the search query. For example, if a parent term and child term appear more than once in a query, the duplicate appearances may be removed. In such an embodiment, child term that include the parent term embedded within them are not eliminated as redundant but are included in the expanded list of search terms (or automatically generated ontology). For example, the system would not eliminate “Protocolitis” from a list that was generated based on the parent term “Colitis,” and both terms would be included in the query. However, any term in which the parent term is distinct from modifying words may be eliminated. For example, if “Ulcerative colitis” were a child term of the parent term “Colitis,” “Ulcerative colitis” would be eliminated from the expanded list because of the redundant whole word mimicking the parent term.

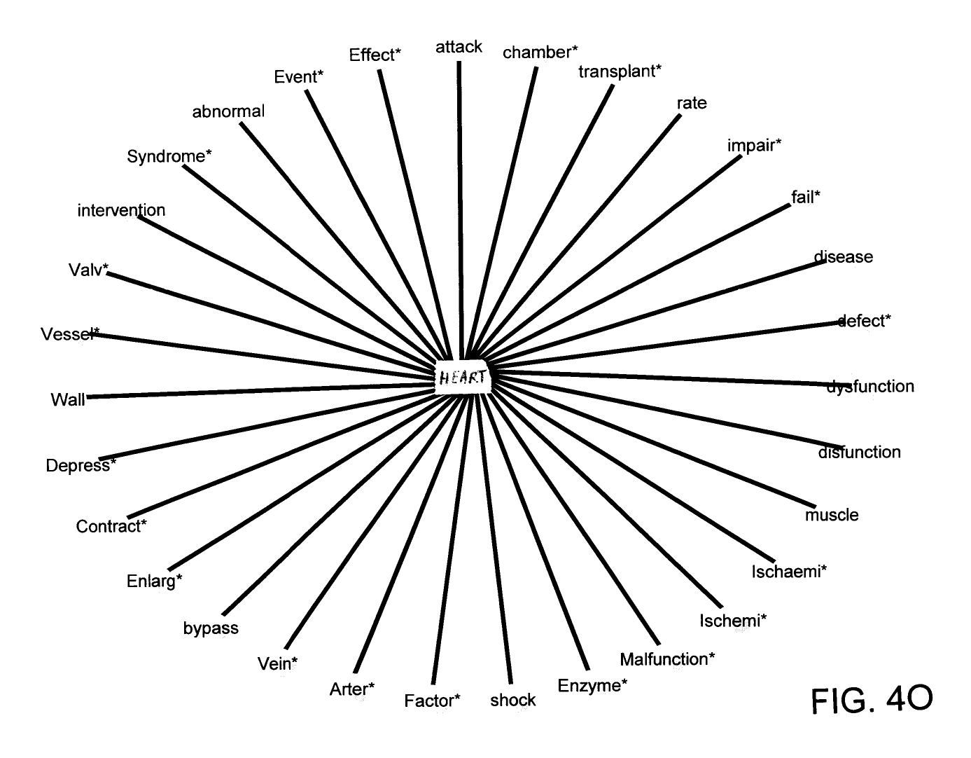

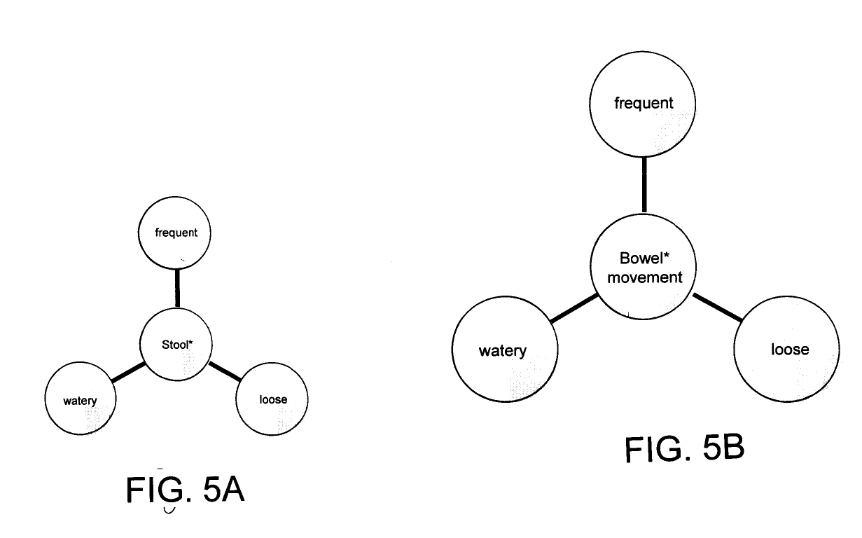

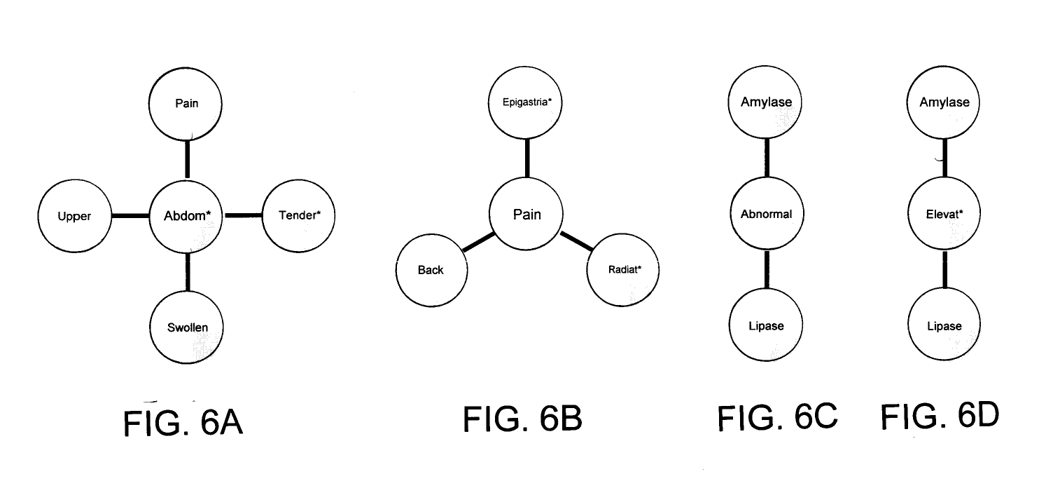

Continuing with the examples of FIGS. 4-7, the heart dysfunction ontology of FIG. 4 is a relatively complex ontology, as compared to the diarrhea ontology of FIG. 5, in which there are two groupings of related terms, and a single independent term, “diarrhea” The pancreas dysfunction ontology of FIG. 6 includes four groupings of related terms, and also includes independent terms: Cullen's Sign; Diabet*; Dyspnea; Ecchymoses of the flank; Eruptive xanthomas*; Gallstone*; Grey-Turner's sign; Hyperglycemia; Hyperglycaemia; Hyperlipidemia; Hyperlipidaemia; IDDM; Insulin; Pancrea*; Purtscher retinopathy; Tachypnea; and Umbilicus. Similarly, the liver dysfunction ontology of FIG. 7 includes four groupings of related terms and independent terms: Jaundice*; and Cholestatic. As will be understood, numerous other ontologies may be generated in a similar fashion an dused for expanding received search terms.

In other embodiments, the search term list may be further expanded by determining if there are synonyms to any of the generated search terms. In such embodiments, after the ontology language processor generates a list of search terms that are all functionally related to the original search term received at the user interface, an external source is then queried to determine if additional functionally related clinical terms can be added to the automatically generated ontology. Such an external source to be explored may be the SNOMED-CT ontology. SNOMED-CT (Systematized Nomenclature of Medicine-Clinical Terms) is a comprehensive clinical terminology, originally created by the College of American Pathologists (CAP) and, as of April 2007, owned, maintained, and distributed by the International Health Terminology Standards Development Organization (IHTSDO), a non-for-profit association in Denmark. The CAP continues to support SNOMED-CT operations under contract to the IHTSDO and provides SNOMED-related products and services as a licensee of the terminology.

In such embodiments, the user interface may provide autofill functionality and linkage to the SNOMED-CT ontology in an external data source. The ontology language processor in an embodiment provides a list of SNOMED-CT preferred terms (PT) (also referred to as “Concepts”) from a list that has been culled of every term that is not categorized by SNOMED-CT as a “disorder,” “finding,” or “event.” Continuing with the liver dysfunction example used above, the entered search term “Elevated LFTs” would not bring up any terms from the SNOMED-CT ontology, and the search would be ready to commence using the 30 search terms that were derived solely from the liver dysfunction ontology of FIG. 7.

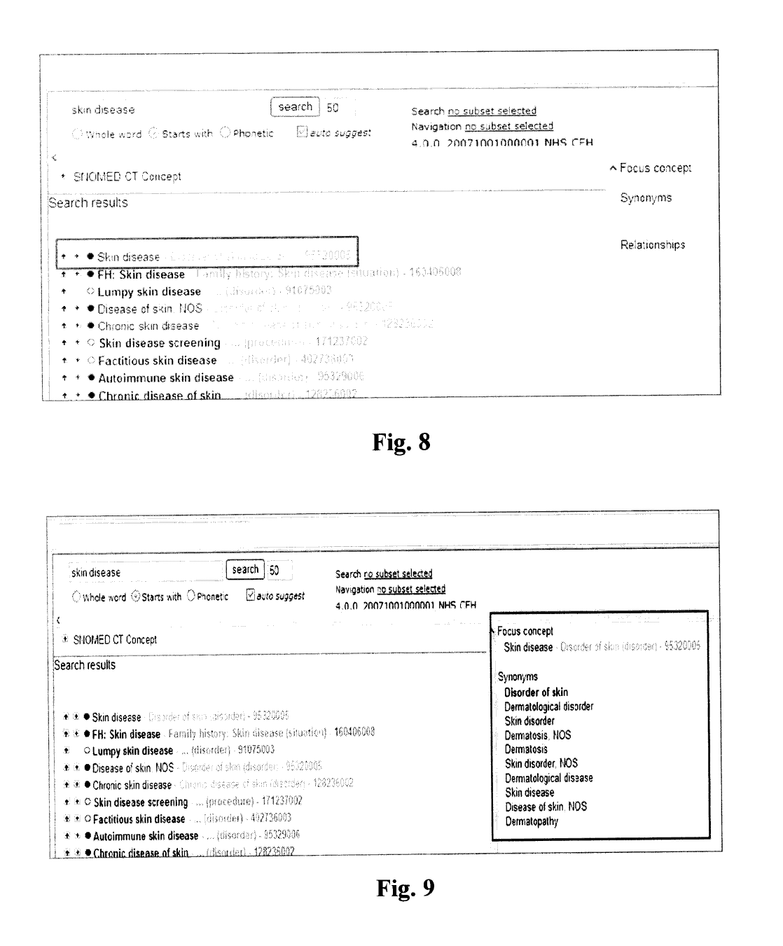

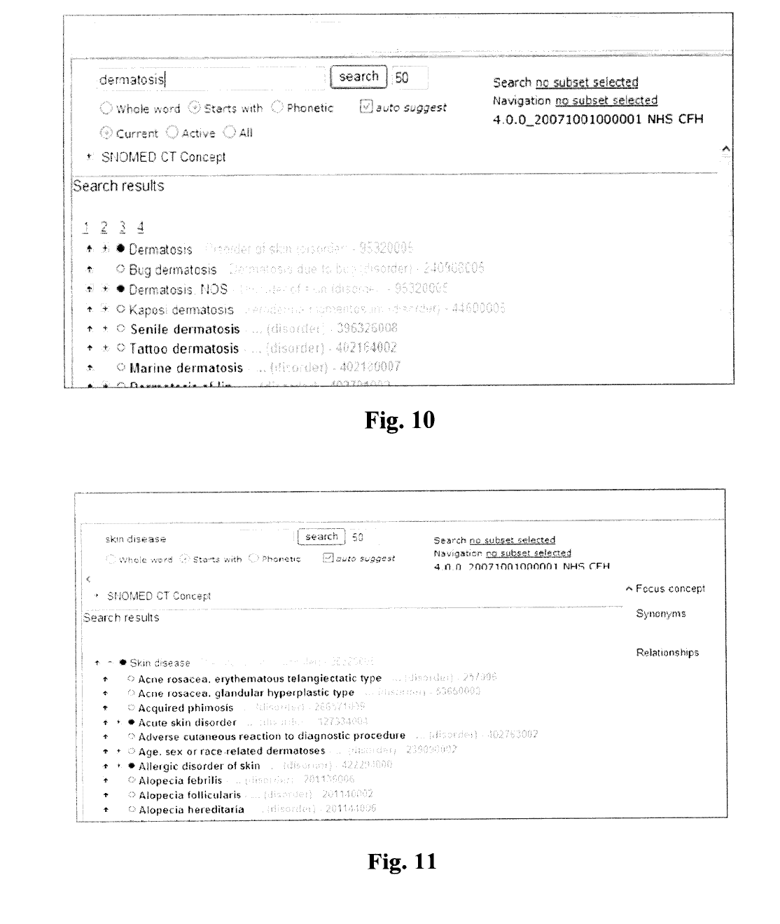

Referring now to FIGS. 8-12, an embodiment is described for an example in which the original search term is “Skin disease.” In such an embodiment, after generating the search terms from a skin dysfunction ontology, the ontology language processor passes the original search term to SNOMED-CT. If the user selects a PT from those offered from the SNOMED-CT, that Concept becomes a term to be captured and added to the terms from the automatically generated ontology. The ontology language processor then “calls” SNOMED-CT, and the selected term (in this case, “Skin disease”) is passed as a parameter to SNOMED-CT. The ontology language processor uses that parameter to access an index of all SNOMED-CT Concepts to see if a SNOMED-CT Concept contains that specific term. The term “Skin disease” is shown entered as a SNOMED-CT search term in a screen shot illustrated in FIG. 8. The ontology language processor then determines whether the term (Skin disease) has any synonyms (as defined in SNOMED-CT), as illustrated in the screen shot of FIG. 9. The ontology language processor captures all synonyms of the PT and re-enters those terms as distinct PTs into the SNOMED-CT search window. In this case, synonyms of “Skin disease” are shown to include several other terms, including, for example, “Dermatosis”. Using “Dermatosis” as an example of what the ontology language processor does with synonyms of PTs, FIG. 10 illustrates a screen shot in which the ontology language processor searches through SNOMED-CT using “Dermatosis” as a PT in order to treat this synonym as an independent PT, and adding additional terms to the list of terms in the automatically generated ontology. The ontology language processor then determines if each of the PTs (original search term+synonyms) has any associated subsets, i.e. is expandable. If any term is expandable within the SNOMED-CT ontology, the term will have a “+” sign in a box to the left of the term, indicating that the term has “child terms”, or subsets, associated with it and that the term is expandable to display those child terms, illustrated in the screen shots of FIGS. 8-10.

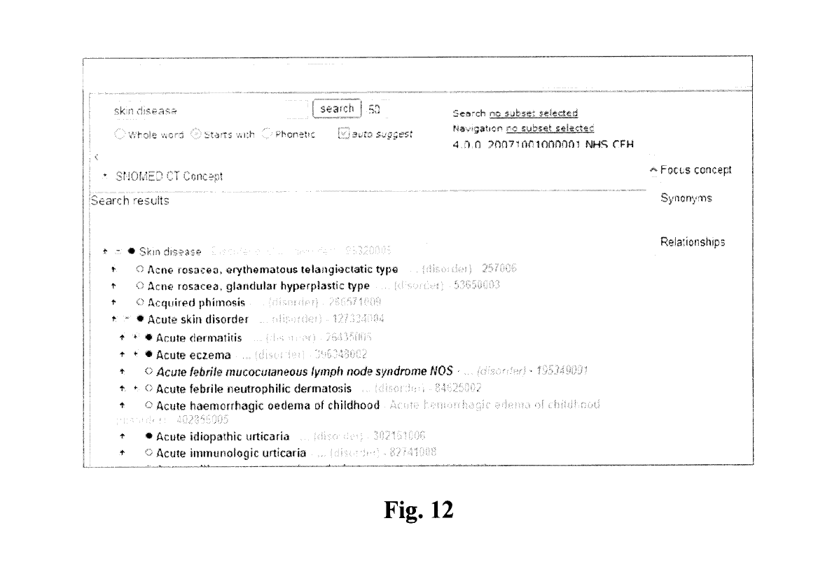

In a case where the term is expandable, the ontology language processor automatically expands the term to include all “Child terms,” or subsets, of that PT, as illustrated in the screen show of FIG. 11, in which the term “Skin disease” has been expanded. Some of the child terms may contain the parent term (PT) in addition to other words, some may contain the PT embedded in a child term, and some child terms may be unique. All child terms that are either unique or contain the PT embedded within them will be added to the search terms of the automatically generated ontology. In cases where child terms are themselves expandable, each of those terms is expanded, and unique terms in those subsets are captured and added to the automatically generated ontology, as illustrated in FIG. 12 for the term, “Acute skin disorder.” When all of the selected terms have been expanded, the ontology language processor then calls another method to expand that set of terms by including the children and the synonyms of their children recursively.

Once the PT and all synonyms have been captured, all unique child terms under those terms have been captured, and all expandable child terms have been expanded for the capture of unique child terms under them, and so on, the SNOMED-CT-derived automatically generated ontology is created and added to the initial automatically generated ontology derived from the dysfunction ontologies.

After the ontology language processor adds all search terms derived from dysfunction ontologies to the list of search terms derived from SNOMED-CT, the ontology language processor may continue the search term expansion process by going to other sources. It then complies the data into an array sorted alphabetically and eliminates redundancies prior to presenting to the user an editable version of the automatically generated ontology.

Prior to the processing engine searching data sources using the automatically generated ontology thus generated, the user, in an exemplary embodiment, has the option of reviewing an editable version of the automatically generated ontology, such that the user is offered an opportunity to “uncheck” or “deselect” any search term in the automatically generated ontology that is not of interest to that user. In addition, a user is allowed to “add” search terms to the automatically generated ontology prior to initiating a search of the data sources using the final, edited automatically generated ontology. Users are also given the ability to “Save as preference” any changes made to an automatically generated ontology associated with a specific PT, so that the next time that user enters that PT, the automatically generated ontology will be modified accordingly.

Further embodiments provide that automatically generated ontologies that are repeatedly altered by distinct users (either through addition or deselection) and stored within the system may be clustered, for example, within a DBMS. Common changes can be saved within a version of that automatically generated ontology known as a “peer-curated” automatically generated ontology, or PCAGO. This is a wiki-approach to ontology generation, and PCAGOs are available to users who may prefer to use these peer-reviewed automatically generated ontologies when time is limited rather than rely on de novo automatically generated ontologies that a user might otherwise feel a need to review and edit. In an exemplary embodiment, a user may select a PCAGO and then further refine and modify the PCAGO prior submitting the query for searching.

Those of skill would further appreciate that the various illustrative logical blocks, modules, circuits, and algorithm steps described in connection with the embodiments disclosed herein may be implemented as electronic hardware, computer software, firmware, or combinations thereof. To clearly illustrate this interchangeability, various illustrative components, blocks, modules, circuits, and steps have been described above generally in terms of their functionality. Whether such functionality is implemented as hardware, software, and/or firmware depends upon the particular application and design constraints imposed on the overall system. Skilled artisans may implement the described functionality in varying ways for each particular application, but such implementation decisions should not be interpreted as causing a departure from the scope of the present invention.

For a hardware implementation, the processing units may be implemented within one or more application specific integrated circuits (ASICs), digital signal processors (DSPs), digital signal processing devices (DSPDs), programmable logic devices (PLDs). field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for generating medical assessment query terms in a medical assessment support system comprising:
receiving a search term describing an adverse event experienced by a patient;
identifying a plurality of clinical terms that are functionally related to said search term; and
providing a medical assessment query to database search in a medical assessment support system, said query comprising said plurality of clinical terms.

2. A method, as claimed in claim 1, wherein:
said medical assessment query further comprising an identification of a drug/treatment having been applied to the patient.

3. A method, as claimed in claim 1, wherein:
said medical assessment query further comprising an identification of a condition/symptom of the patient.

4. A method, as claimed in claim 1, wherein:
said medical assessment query further comprising an identification of a drug/treatment having been applied to the patient and a condition/symptom of the patient.

5. A method, as claimed in claim 1, wherein said receiving a search term comprises:
receiving a portion of a search term; and
providing a suggested search term based on said received portion of a search term.

6. A method, as claimed in claim 1, wherein identifying said plurality of clinical terms comprises:
determining an ontology that includes said search term, said ontology comprising a plurality of groups of related terms; and
identifying said plurality of clinical terms based on predetermined rules related to said plurality of groups of related terms.

7. A method, as claimed in claim 6, wherein:
at least one of said plurality of groups of related terms comprises a hierarchy of terms that include directly related terms and indirectly related terms, and said plurality of clinical terms comprises each combination of directly related terms of said hierarchy.

8. A method, as claimed in claim 1, wherein identifying said plurality of clinical terms comprises:
establishing, using an electronic communication device, a communication link with a systemized nomenclature database that provides a database search based upon a query and identifies synonyms, if any, for the query;
sending a query to a systemized nomenclature database using said electronic communication device, said query comprising at least a portion of said search term; and
receiving, in response to said step of sending, results of a database search conducted by a systemized nomenclature database based upon said query and identifying any synonyms of said query term(s).

9. A method, as claimed in claim 8, further comprising, for each synonym identified by the database search:
sending a query to a systemized nomenclature database using said electronic communication device, said query comprising a synonym; and
receiving, in response to said step of sending, results of a database search conducted by a systemized nomenclature database based upon said query and identifying any synonyms of said search term.

10. A method, as claimed in claim 9, wherein identifying said plurality of clinical terms further comprises removing any redundant clinical terms identified in results of the database searches.

11. A method, as claimed in claim 1, wherein identifying said plurality of clinical terms comprises:
determining an ontology that includes said search term, said ontology comprising a plurality of groups of related terms;
identifying a plurality of query terms based on predetermined rules related to said plurality of groups of related terms;
establishing, using an electronic communication device, a communication link with a systemized nomenclature database that provides a database search based upon a query and identifies synonyms, if any, for the query;
sending a query, for each identified query term, to a systemized nomenclature database using said electronic communication device, said query comprising at least a portion of an identified query term; and
receiving, in response to said step of sending, results of a database search conducted by a systemized nomenclature database based upon said query and identifying any synonyms of said query term(s).

12. A method, as claimed in claim 11, further comprising, for each synonym identified by the database search:
sending a query to a systemized nomenclature database using said electronic communication device, said query comprising a synonym; and
receiving, in response to said step of sending, results of a database search conducted by a systemized nomenclature database based upon said query and identifying any synonyms of said search term.

13. A method, as claimed in claim 12, wherein identifying said plurality of clinical terms further comprises removing any redundant clinical terms identified in results of the database searches.

14. A method, as claimed in claim 1, further comprising:
providing said plurality of clinical terms to a third party for review;
storing said reviewed clinical terms; and
providing said reviewed clinical terms as said plurality of clinical terms in response to receiving said search term.

15. A method, as claimed in claim 14, wherein said identifying a plurality of clinical terms that are functionally related to said search term comprises providing said reviewed clinical terms, and further providing said reviewed clinical terms to a user for review and modification.

16. A method for providing an ontology-based search term expansion, comprising:
establishing a communication link with an automated ontology generation system using an electronic communication device;
sending a query to an automated ontology generation system using said electronic communication device, said query comprising a search term;
receiving, in response to said step of sending, a plurality of related search terms from an automated ontology generation system and from a database search conducted by a systemized nomenclature database based upon said query and identifying at least one synonym of said query term.

17. A method, as claimed in claim 16, wherein:
said plurality of related search terms being determined from an ontology that includes said search term, said ontology comprising a plurality of groups of related terms, and being based on predetermined rules related to said plurality of groups of related terms.

18. A method, as claimed in claim 17, wherein:
at least one of said plurality of groups of related terms comprises a hierarchy of related terms including directly related terms and indirectly related terms, and said plurality of clinical terms comprises each combination of directly related terms of said hierarchy.

19. A system for providing an ontology-based search term expansion comprising:
an user interface for receiving a query from an electronic communication device associated with a user and sending the results of a search term expansion based on said query to an electronic communication device associated with the user;
a processing engine for determining an ontology based upon a query received by said input interface and providing a plurality of search terms to said user interface for subsequent transmission to an electronic communication device associated with the user;
wherein said processing engine comprises an ontology processor for processing at least a portion of said query to produce additional search terms based on an ontology of a plurality of ontologies that includes said search term, said ontology comprising a plurality of groups of related terms; and
a data interface for conducting communications with an external data source that may be able to provide one or more synonyms relevant to said query.

20. A system, as claimed in claim 19, wherein:
said plurality ontologies comprise groups of related terms, at least one ontology comprising a hierarchy of related terms; and
said ontology processor produces said additional search terms based on predetermined rules corresponding to relationships of terms of said hierarchy.

21. A system, as claimed in claim 19, wherein:
said query is a repeating query that identifies one or more additional search terms based on synonyms provided from said external data source;
said processing engine repeatedly searching for additional search terms based on said repeating query.

22. A system, as claimed in claim 21, wherein said processing engine removes any redundant clinical terms identified in said queries.
